(19) United States
(12) Patent Application Publication
(10) Pub. No.: US 2018/0128246 A1
(43) Pub. Date: May 10, 2018

(54) WIND TURBINE COMPRISING A TOWER PART OF AN ULTRA-HIGH PERFORMANCE FIBER REINFORCED COMPOSITE

(71) Applicant: Forida Development A/S, Hjallerup (DK)

(72) Inventors: Lars Rom Jensen, Aalborg SV (DK); Jan Karlsen, Hjallerup (DK)

(21) Appl. No.: 15/798,288

(22) Filed: Oct. 30, 2017

Related U.S. Application Data
(63) Continuation of application No. 14/390,758, filed on Jan. 19, 2015, now abandoned.

(51) Int. Cl. E04H 12/08; E04H 12/16

(52) U.S. Cl. CPC F03D 9/34; F03D 13/20; E04H 12/08; E04H 12/16; F05B 2240/912; F05B 2280/6003; Y02E 10/726; Y02E 10/728; F03D 9/25

(57) ABSTRACT

A wind turbine generator is disclosed. The wind turbine generator comprises a nacelle and rotor, and a tower between said nacelle and a foundation. The tower comprises an ultra-high performance fiber reinforced composite (UHPFRC) tower part extending from the foundation. The tower includes at least four tower segments arranged on top of each other to form a column, and pre-tensioning steel strands or bars for pre-tensioning the tower segments in a vertical direction. The UHPFRC tower part is made in a UHPFRC with a percentage of steel fibers per volume in the range of 0.5 to 9, such as 1 to 6, and preferably in the range of 2 to 4.

The present invention relates to a wind turbine generator comprising a nacelle and rotor, and a tower between said nacelle and a foundation, wherein said tower comprises a composite tower part extending from the foundation and including at least four tower segments arranged on top of each other to form a column.

### BACKGROUND

Wind turbine towers have the purpose of supporting the nacelle carrying the rotor with normally two or three blades at an elevated position, where the influence of the ground on the wind speed is low. The tower must be designed for taking up the relevant stress during all operating and non-operating situations without being subject to failure or fatigue within the expected lifetime of the wind turbine. The relevant stress origins from act of gravity on the nacelle and the tower, from the shear forces from the aerodynamic drag force on the wind turbine rotor during operation of the wind turbine and from a torque on the tower due the action of said aerodynamic drag force on the rotor. The torque is the decisive contribution for the design of the lower part of the wind turbine tower near the foundation.

The construction of at least a part of the wind turbine tower from segments of composite materials, in particular from concrete is well-known in the art and is described e.g. in the European patent application No. 1 474 579 A1 (Mecal) which relates to a wind turbine comprising a stationary vertical tower which is at least partly composed from prefabricated concrete wall parts, with several adjacent wall parts forming a substantially annular tower segment. Similar concrete tower for wind turbines are described in U.S. Pat. No. 7,765,766 (Inneo Torres) and in U.S. Pat. No. 7,770,343 (Structural Concrete & Steel).

It is an object of the present invention to provide a wind turbine with an improved segmented wind turbine tower made from composite material.

### SUMMARY

High-performance types of composite materials have been known for a number of years, such as ultra-high performance fiber-reinforced composite (UHRFPC), which is a group or family of materials which has exceedingly high durability and compressive strength. It is a high strength ductile material formulated from a special combination of constituent materials. These materials include a binder comprising Portland cement and microsilica (also known as silica fume) and other constituent materials such as quartz flour, fine silica sand, fly ash, water and fibers such as either steel fibers, organic fibers, plastic material fibers, carbon fibers or combinations of these. These materials have been suggested used in wind turbine towers mainly for parts that are subject to high demands, such as foundation parts in off-shore wind turbine generators.

However, use of these materials for the lower part of the tower which is subjected to a large torque as discussed previously would have been disregarded because the tower construction required to sustain the torque and its consequences, in particular buckling of the tower wall, i.e. a wide diameter of the tower and high average wall thickness of the tower would not benefit from the advantageous characteristics of the composite material. The use of such high performance materials would therefore be an expensive solution since the material is both costly in use and laborious to manufacture larger parts from.

With the present invention it has surprisingly been realized the use of an ultra-high performance fiber reinforced composite with a specific content of steel fibers, i.e. with a percentage of steel fibers per volume in the range of 0.5 to 9, such as 1 to 6 and preferably in the range of 2 to 4 for manufacture of segments for a segmented wind turbine tower which allows for a slender construction of the segment, i.e. that the wall thickness can be substantially reduced as compared to segments made from concrete.

Thus, the present invention relates to a wind turbine generator comprising a nacelle and rotor, and a tower between said nacelle and a foundation, wherein said tower comprises an ultra-high performance fiber reinforced composite (UHPFRC) tower part extending from the foundation and including at least four tower segments arranged on top of each other to form a column, and pre-tensioning steel strands or bars for pre-tensioning said tower segments in a vertical direction, wherein said UHPFRC tower part is made in a UHPFRC with a percentage of steel fibers per volume in the range of 0.5 to 9, such as 1 to 6, and preferably in the range of 2 to 4.

More particular, it is preferred that the lowermost tower segment of the UHPFRC tower part has an average wall thickness in the range of 65 to 115 millimeters, preferably in the range of 80 to 100 millimeters. By the term average wall thickness is understood the wall thickness of a section having the same exterior peripheral shape, the same cross-sectional area and a uniform wall thickness. In a particular preferred embodiment, the average wall thickness of the UHPFRC tower part at any given cross-section of the lower half of the UHPFRC tower part except for horizontal joints between adjacent tower segments is in the range of 65 to 130 millimeters, preferably in the range of 80 to 115 millimeters. This low average thickness of the segment walls is made possible by the selection of the UHPFRC with content of steel fibers as discussed previously, and the thin walled segments have the advantages of being low-cost in manufacturing and transportation of the pre-cast segments or pre-cast wall sections for forming the segments to the construction site.

It is likewise preferred that an average wall thickness of the UHPFRC tower part at any given cross-section of the upper half of the UHPFRC tower part except for horizontal joints between adjacent tower segments is in the range of 80 to 150 millimeters, preferably in the range of 90 to 130 millimeters.

All in all, it is preferred that an average wall thickness of the UHPFRC tower part at any given cross-section except for horizontal joints between adjacent tower segments is in the range of 65 to 150 millimeters, preferably in the range of 80 to 130 millimeters.

The segments are preferably of a shape tapered toward the upper end of the UHPFRC tower part so that the UHPFRC tower part is of a tapered design, which is advantageous in that a broader root diameter is suitable for enduring the torque at the tower root whereas a more slim outer shape at a higher vertical position reduces the wind load on the construction. The magnitude of the taper toward the upper end of the UHPFRC tower part is advantageously in the range of 4.5 to 8.5%, preferably in the range of 5.5% to 7.5%, the taper being defined as the difference between the diameters of the circumscribed circles at the top of UHPFRC tower part and the bottom of the UHPFRC tower part divided by the vertical height of the UHPFRC tower part.

The outer diameter of the lowermost tower segment of the UHPFRC tower part is preferably in the range of 6 to 14 meter, more preferably in the range of 8 to 12 meter. The outer diameter is herein for a tower part of a circular cross-section the same as the diameter of the outer perimeter, whereas it for a tower part of a polygon cross-section is understood as the diameter of the circumscribed circle.

It is preferred that the length of the steel fibers in the UHPFRC tower part is in the range of 4 to 50 mm, such as 6 to 20 mm and preferably in the range of 8 to 16 mm. Also, it is preferred that the diameter of the steel fibers in the UHPFRC tower part is in the range of 0.1 to 0.6 mm, preferably in the range of 0.3 to 0.5 mm. It is herein understood that these numbers apply to the majority of the steel fibers in the UHPFRC, such as at least 85%, preferably at least 95% of said percentage of steel fibers per volume of UHPFRC.

It is furthermore preferred that the UHPFRC of said UHPFRC tower part comprises microsilica in the range of 6% to 20% by weight of the binder material of the UHPFRC. Microsilica is also known as “silica fume” or Condensed Silica Fume (CSF).

Also, it is preferred that the UHPFRC of said UHPFRC tower part comprises superplastifier in the range of 0.5% to 3% by weight of the binder material of the UHPFRC. By the term binder material is understood the contents of binders, in particular of cement, such as Portland cement, of fly ash and of microsilica.

The present invention is in particular advantageous when the tower is a hybrid tower comprising an upper steel tower part extending between the nacelle and the UHPFRC tower part. The hybrid tower is an advantageous choice because the upper steel tower part is highly suited to take up the stresses from the gravity on the nacelle and rotor as well as the shear forces caused by the aerodynamic drag on the rotor, whereas the UHPFRC tower part is suited for taking up the dominant torque at the lower part of the tower. The vertical extend of the upper steel tower part is preferably in the range of 80% to 125% of the radius of the rotor, and it is advantageous that the steel tower parts extents at least to the tip of the blades of the rotor so that the tip of the blades can pass the tower without risk of colliding with the tower due to wind-induced deflection of the blades as the steel tower part can be manufactured with a lower outer diameter than the UHPFRC tower part. The ratio of vertical extend of the steel tower part to the UHPFRC tower part is advantageously within the range of 0.5 to 1.4, preferably in the range of 0.65 to 0.9.

The wind turbine according to the present invention is preferably of such a design that in the static situation when the wind turbine is not subjected to aerodynamic forces the UHPFRC tower part is subjected to a vertical compressive stress in the range of 10 to 50 MPa and preferably in the range of 15 to 40 MPa. It is particularly preferred that the uppermost tower segment of the UHPFRC tower part when the wind turbine is not subjected to aerodynamic forces is subjected to a vertical compressive stress in the range of 15 to 50 MPa and preferably in the range of 20 to 40 MPa.

Also, the wind turbine according to the present invention is preferably of such a design that when the wind turbine is operating and delivers its nominal power output, the UHPFRC tower part is subjected to a maximal vertical compressive design stress in the range of 25 to 75 MPa and preferably in the range of 35 to 60 MPa. By the term nominal power output is understood the power output the wind turbine is design for and is controlled to operate with the nominal power as an upper limit for the ordinary production. The nominal power is also known as the nameplate capacity of the wind turbine.

The pre-tensioning steel strands or bars are preferably applying a vertical compressive stress in the range of 10 to 50 MPa and preferably in the range of 15 to 40 MPa to the UHPFRC tower part when the wind turbine is not subjected to aerodynamic forces.

The pre-tensioning steel strands or bars are preferably directed on the inner surface of said lower UHPFRC tower part.

The UHPFRC tower part is preferably so designed that the ratio (d/t) of an average wall thickness (t) and the corresponding equivalent diameter (d) of the circumscribed circle of the UHPFRC tower part at any given cross-section of the lower half of the UHPFRC tower part except for vertical joints between adjacent tower segments is in the range of 60 to 150.

Each of the at least four tower segments of the UHPFRC tower part are preferably constituted by a plurality of wall sections with substantially vertical connections, preferably at least three wall sections per UHPFRC tower part segment. Hereby, production of the segments as prefabricated wall sections and the subsequent transportation of the wall sections to the construction site of the wind turbine is made feasible.

The vertical extend of each of the at least four tower segments of the UHPFRC tower part are preferably within the range of 5 to 20 meters, preferably in the range of 7 to 15 meters.

The vertical extend of the whole UHPFRC tower part is preferably in the range of 45 to 150 meters, preferably in the range of 60 to 100 meters.

### BRIEF DESCRIPTION OF THE DRAWINGS

The present invention is illustrated with a preferred embodiment described in the following with reference to the drawing of which

FIG. 1 is a side view of a wind turbine generator,

FIG. 2a is a horizontal cross section view of a segment of the wind turbine tower, and

FIG. 2b is a horizontal cross section view of an alternative embodiment of a segment of the wind turbine tower.

### DETAILED DESCRIPTION OF EMBODIMENTS

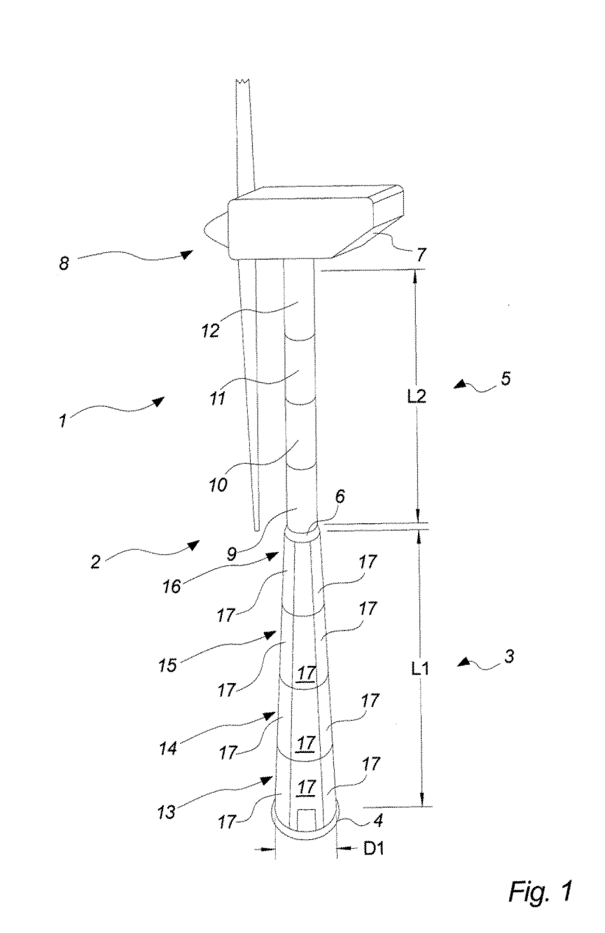

The wind turbine generator 1 shown in FIG. 1 comprises a tower 2 having a lower part 3 made from ultra-high performance fiber reinforced composite (UHPFRC) material and placed on a foundation 4 (only partly shown on FIG. 1) and an upper part 5 made from steel. A transition piece 6 is provided between the lower part 3 and the upper part 5 of the tower 2. A nacelle 7 is arranged on top of the upper part 5 of the tower 2 carrying a three-bladed rotor 8 which is rotatable about a substantially horizontal axis.

The upper part 5 of the tower comprises in the present embodiment four hollow steel segments 9, 10, 11, 12 that are of a circular cross-section and together are tapering towards the upper end where the nacelle 7 is arranged, so that the bottom diameter of the lowermost segment 9 is 4.2 meter whereas the top diameter of the uppermost segment. The steel segments 9, 10, 11, 12 are joined together by means of horizontal flange assemblies (not shown) to form a single unit of a height L2 of about 60 meters.

The lower part 3 of the tower comprises in the present embodiment four hollow segments 13, 14, 15, 16 which each are assembled at the construction site from four prefabricated wall sections 17 made from UHPFRC covering a steel reinforcement grid. The wall sections 17 are provided with longitudinal side flanges 18 forming the vertical connecting element to the neighbouring wall section 17 and the flanges 18 are formed with a longitudinal indentation 19 which during assembly of the segment 13, 14, 15, 16 is filled with a cement-based mortar 23 so that the four wall sections 17 after hardening form a segment 13, 14, 15, 16. Each segment 13, 14, 15, 16 is formed by four identical wall sections 17. The four segments 13, 14, 15, 16 can be arranged on top of each other and the horizontal joints between the neighbouring segments 13, 14, 15, 16 are secured by means of an adhesive, such as a two-component polyurethane or epoxy to form a single column. The lower part 3 of the tower 2 is tapering towards the upper part 5 of the tower 2 from a bottom diameter of the lowermost segment 13 of 9.4 meter to a top diameter of 4.7 meter of the uppermost segment 16.

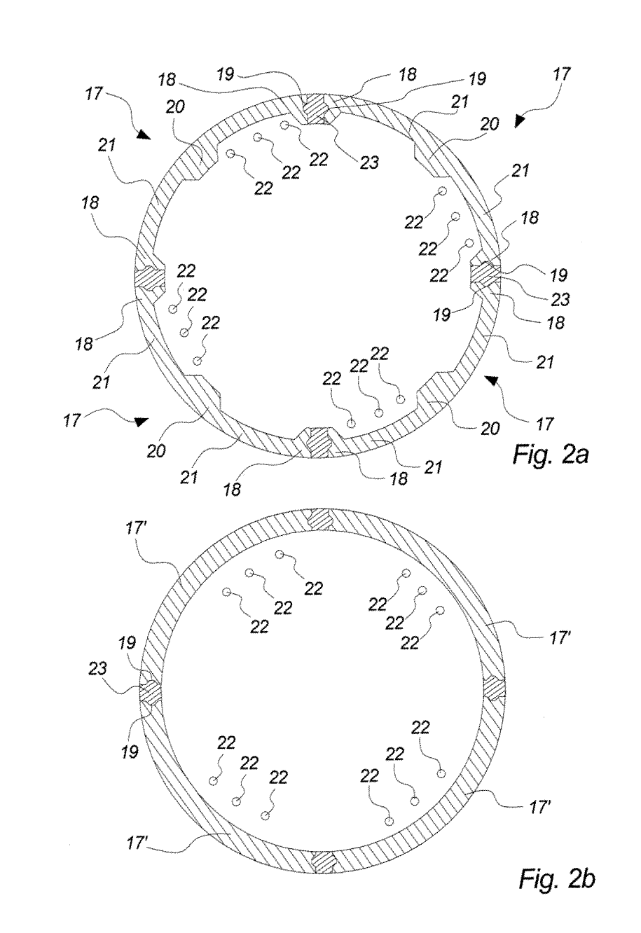

In a first embodiment of the UHPFRC segments 13, 14, 15, 16 as shown in cross-section in FIG. 2a, the individual wall element 17 comprises two longitudinal flanges 18 and a central rib 20 extending longitudinally there between, the flanges 18 and the rib 20 having a first thickness in the radial direction of the segment 13, 14, 15, 16, i.e. in the direction from the centre of the segment 13, 14, 15, 16 and outwards, and the intermediate wall parts 21 having a second thickness in the radial direction being smaller than the first thickness. A typical value for the first thickness is in the range of 350 to 450 millimeter whereas a typical value for the second thickness is in the range of 50 to 80 millimeter. An average wall thickness of a cross-section of the segment may be calculated to be the wall thickness of a section having the same exterior peripheral shape of the segment, the same cross-sectional area of the wall and a uniform wall thickness. Such average wall thickness is preferably in the range of 80 to 130 millimeter.

In an alternative second embodiment of the UHPFRC segments 13, 14, 15, 16 as shown in cross-section in FIG. 2b, the individual wall element 17′ is of a uniform thickness throughout the horizontal section, and that thickness is preferably in the range of 80 to 130 millimeters.

The segments 13, 14, 15, 16 of the UHPFRC part 3 of the tower 2 are pre-tensioned in the vertical direction by means of a set of pre-tensioning strands 22 extending from the foundation 4 or the lower part of the lowermost segment 13 to the transition piece 6 or to the top of the uppermost segment 16 or alternatively to the steel part 5 of the tower 2. The function of the pre-tensioning strands is to prevent that the total vertical compressive stress on the lower UHPFRC part 3 of the tower 2, i.e. the sum of the load from the aerodynamic forces on the wind turbine generator 1, mainly on the rotor 8 and the load from gravity forces becomes less than zero at any part of the lower part 3, that is to prevent that any part of the lower part 3 of the tower 2 is subjected to a vertical tensile force during operation of the wind turbine generator 1. The pre-tensioning strands 22 are adjusted to apply a vertical compressive stress in the range of 25 to 35 MPa to the UHPFRC segments 13, 14, 15, 16.

The UHPFRC from which the wall elements 17, 17′ are precast is made from a mix of water and dry components in the following composition:

700 kg Compact Reinforced Composite (CRC) binder,
550 kg of 0/2 mm sand,
300 kg of 2/4 mm sand,
740 kg of 4/8 mm gravel,
120 kg of steel fibers (length 12 mm and diameter 0.4 mm), and
95 kg of water

The CRC binder being a mixture of white Portland cement, microsilica and dry superplastifier, where the microsilica typically constitutes 6 to 20% of the binder weight and the superplastifier constitutes about 0.5 to 3% by weight of the binder material.

The contents of steel fibers results in a UHPFRC in the wall elements 17, 17′ with a percentage of steel fibers per volume of 2.4.

The mortar applied to cast the joints 23 between the wall elements 17, 17′ is made from a similar UHPRFC material where the percentage of steel fibers per volume of is substantially higher, such as about 6% in order to obtain a stronger connection between the wall elements 17, 17′.

The overall dimensions of the segments 13, 14, 15, 16 of the lower part 5 of the tower 2 are given in the table below. The average wall thickness increases from the bottom towards the top of the lower part 5 as the outer diameter as shown in the table decreases and so as to maintain a substantially constant horizontal area of the lower part 5.

| | | | | Average wall |
|---|---|---|---|---|
| Segment | Height | Diameter top | Diameter bottom | thickness |
| (ref. No.) | (meter) | (meter) | (meter) | (millimetre) |
| 13 | 20 | 8.3 | 9.4 | 90 |
| 14 | 20 | 7.2 | 8.3 | 96 |
| 15 | 20 | 6.1 | 7.2 | 102 |
| 16 | 20 | 5.0 | 6.1 | 108 |

### LIST OF REFERENCE NUMERALS

1 Wind turbine generator
2 Tower
3 Lower part of the tower
4 Foundation
5 Upper part of the tower
6 Transition piece
7 Nacelle
8 Three-bladed rotor
9 Lowermost steel segment
10 Second steel segment
11 Third steel segment
12 Uppermost steel segment
13 Lowermost UHPRFC segment
14 Second UHPRFC segment
15 Third UHPRFC segment
16 Uppermost UHPRFC segment
17 Wall element of first embodiment
17′ Wall element of second embodiment
18 Longitudinal side flange of wall element
19 Longitudinal indentation in flange
20 Longitudinal rib in wall element
21 Intermediate wall part
22 Pre-tensioning strands
23 Mortar joint
L1 Height of lower part of the tower
L2 Height of upper part of the tower
D1 Lowermost diameter of the lower part of the tower
UHPFRC Ultra-high performance fiber reinforced composite

What is claimed is:

1. Wind turbine generator (1) comprising
a nacelle (7) and rotor (8), and
a tower (2, 3, 5) between said nacelle and a foundation (4), wherein said tower comprises
an ultra-high performance fiber reinforced composite (UHPFRC) tower part (3) extending from the foundation (4) and including at least four tower segments (13, 14, 15, 16) arranged on top of each other to form a column, and
pre-tensioning steel strands or bars (22) for pre-tensioning said tower segments (13, 14, 15, 16) in a vertical direction,
wherein said UHPFRC tower part (3) is made in a UHPFRC with a percentage of steel fibers per volume in the range of 0.5 to 9, such as 1 to 6, and preferably in the range of 2 to 4,
wherein an average wall thickness of the lowermost tower segment (13) of the UHPFRC tower part (3) is in the range of 65 to 115 millimeters, preferably in the range of 80 to 100 millimeters,
wherein the tower (2) is a hybrid tower comprising an upper steel tower part (5, 9, 10, 11, 12) extending between the nacelle (7) and the UHPFRC tower part (3) and the vertical extend (L2) of the upper steel tower part (5) is in the range of 80% to 125% of the radius of the rotor (8),
wherein the UHPFRC tower part (3) when the wind turbine generator (1) is not subjected to aerodynamic forces is subjected to a vertical compressive stress in the range of 10 to 50 MPa and preferably in the range of 15 to 40 MPa by means of said pre-tensioning steel strands or bars (22), and
wherein the vertical extend of the UHPFRC tower part (3) is in the range of 45 to 150 meters, preferably in the range of 60 to 100 meters.

2. Wind turbine generator according to claim 1, wherein an average wall thickness of the UHPFRC tower part (3) at any given cross-section of the lower half of the UHPFRC tower part (3) except for horizontal joints between adjacent tower segments (13, 14, 15) is in the range of 65 to 130 millimeters, preferably in the range of 80 to 115 millimeters.

3. Wind turbine generator according to claim 1, wherein an average wall thickness of the UHPFRC tower part (3) at any given cross-section of the upper half of the UHPFRC tower part (3) except for horizontal joints between adjacent tower segments (14, 15, 16) is in the range of 80 to 150 millimeters, preferably in the range of 90 to 130 millimeters.

4. Wind turbine generator according to claim 1, wherein an average wall thickness of the UHPFRC tower part (3) at any given cross-section except for horizontal joints between adjacent tower segments (13, 14, 15, 16) is in the range of 65 to 150 millimeters, preferably in the range of 80 to 130 millimeters.

5. Wind turbine generator according to claim 1, wherein said segments (13, 14, 15, 16) have a shape tapered toward the upper end of the UHPFRC tower part (3).

6. Wind turbine according to claim 5, wherein the taper toward the upper end of the UHPFRC tower part (3) is in the range of 4.5 to 8.5%, preferably in the range of 5.5% to 7.5%, the taper being defined as the difference between the diameters of the circumscribed circles at the top of UHPFRC tower part (3) and the bottom of the UHPFRC tower part (3) divided by the vertical height (L1) of the UHPFRC tower part (3).

7. Wind turbine generator according to claim 1, wherein the outer diameter of the lowermost tower segment (13) of the UHPFRC tower part is in the range of 6 to 14 meter, preferably in the range of 8 to 12 meter.

8. Wind turbine generator according to claim 1, wherein the length of the steel fibers in the UHPFRC tower part (3) is in the range of 4 to 50 mm, such as 6 to 20 mm, and preferably in the range of 8 to 16 mm.

9. Wind turbine generator according to claim 1, wherein the diameter of the steel fibers in the UHPFRC tower part is in the range of 0.1 to 0.6 mm, preferably in the range of 0.3 to 0.5 mm.

10. Wind turbine generator according to claim 1, wherein the UHPFRC of said UHPFRC tower part (3) comprises microsilica in the range of 6% to 20% by weight of the binder material of the UHPFRC.

11. Wind turbine generator according to claim 1, wherein the UHPFRC of said UHPFRC tower part (3) comprises superplastifier in the range of 0.5% to 3% by weight of the binder material of the UHPFRC.

12. Wind turbine generator according to claim 1, wherein the ratio of vertical extend (L2) of the steel tower part (5) to the UHPFRC tower part (3) is within the range of 0.5 to 1.4, preferably in the range of 0.65 to 0.9.

13. Wind turbine generator according to claim 1, wherein said UHPFRC tower part (3) when the wind turbine is not subjected to aerodynamic forces is subjected to a vertical compressive stress in the range of 10 to 50 MPa and preferably in the range of 15 to 40 MPa.

14. Wind turbine generator according to claim 1, wherein the uppermost tower segment (16) of the UHPFRC tower part (3) when the wind turbine generator (1) is not subjected to aerodynamic forces is subjected to a vertical compressive stress in the range of 15 to 50 MPa and preferably in the range of 20 to 40 MPa.

15. Wind turbine generator according to claim 1, wherein said UHPFRC tower part (3) when the wind turbine generator (1) is operating and delivers its nominal power output is subjected to a maximal vertical compressive stress in the range of 25 to 75 MPa and preferably in the range of 35 to 60 MPa.

16. Wind turbine generator according to claim 1, wherein said pre-tensioning steel strands or bars (22) are directed on an inner surface of said lower UHPFRC tower part (3).

17. Wind turbine generator according to claim 1, wherein the ratio (d/t) of an average wall thickness (t) and the corresponding equivalent diameter (d) of the circumscribed circle of the UHPFRC tower part (3) at any given cross-section of the lower half of the UHPFRC tower part (3) except for vertical joints between adjacent tower segments (13, 14, 15) is in the range of 60 to 150.

18. Wind turbine generator according to claim 1, wherein each of said at least four tower segments (13, 14, 15, 16) of the UHPFRC tower part (3) are constituted by a plurality of wall sections (17, 17′) with substantially vertical connections (18, 19, 23), preferably at least three wall sections (17, 17′) per UHPFRC tower part segment (13, 14, 15, 16).

19. Wind turbine generator according to claim 1, wherein the vertical extend of each of the at least four tower segments (13, 14, 15, 16) of the UHPFRC tower part (3) are within the range of 5 to 20 meters, preferably in the range of 7 to 15 meters.

20. Use of a wind turbine generator according to claim 1 in a wind park.
